(19) United States
(12) Patent Application Publication
(10) Pub. No.: US 2017/0225310 A1
(43) Pub. Date: Aug. 10, 2017

(54) OPERATION ASSEMBLY OF A HAMMER TACKER

(71) Applicant: Tsung-Wen HUANG, Chang Hua County (TW)

(72) Inventor: Tsung-Wen HUANG, Chang Hua County (TW)

(21) Appl. No.: 15/019,993

(22) Filed: Feb. 10, 2016

(51) Int. Cl. B25C 5/11

(52) U.S. Cl. CPC B25C 5/11

(57) ABSTRACT

A hammer tacker includes a body having a nail track, an operation assembly and a strike plate. The operation assembly drives the strike plate to eject the nails. The operation assembly includes an operation unit which has a passive end to drive a resilient member located above the nail track. The resilient member provides the operation assembly a force to return to its initial position. The resilient member has one end mounted to a positioning member which has an insertion inserted into one end of the resilient member, and a flange extends outward from one end of the insertion. The flange has an end face contacts the passive end of the operation unit so as to ensure the resilient member to be operated in a horizontal direction.

### BACKGROUND OF THE INVENTION

1. Fields of the Invention

The present invention relates to a hammer tacker, and more particularly, to an operation assembly of a hammer tacker.

2. Descriptions of Related Art

The conventional hammer tacker is disclosed in FIGS. 5 and 6, and comprises a body 50, a nail tack 51, an activation member 52, a strike plate 53, two links 54, an operation assembly 55 and a resilient member 56. The two links 54 are located on two sides of the operation assembly 55 and pivotably connected to the body 50 by a pivot 541. The front ends of the links 54 are connected with the activation member 52, and the rear ends of the two lings 54 are pivotably connected with another pivot 542 and the operation assembly 55. The operation assembly 55 has one end thereof connected with the strike plate 53 so as to eject nails. The strike plate 53 has one end thereof connected to the body 50 by a fixing member 551. The fixing member 551 has a hooking portion 552 which is hooked to one end of the resilient member 56, and the other end of the resilient member 56 is fixed to a fixed member 57 in the body 50.

When using the hammer tacker, the activation member 52 on the front end of the body 50 hits the object to be nailed, the activation member 52 moves upward by the reaction force of the object so as to pivot the links 54 about the pivot 541, and pivot 542 is lowered to pivot the operation assembly 55 about the fixing member 551 to move the strike plate 53 to eject the nail. When the ejection of the nail is completed, the resilient member 56 moves the operation assembly 55, the links 54 and the activation member 52 back to their initial positions, and the strike plate 53 is moved upward.

However, as shown in FIG. 5, the resilient member 56 is orientated as a tilt status when the hammer tacker is not used, the end that is connected with the hooking portion 552 is lifted upward relative to the end that is connected to the fixed member 57. When the operation assembly 55 is pivoted to lower the strike plate 53, the resilient member 56 is compressed and forced to be operated in horizontal direction as shown in FIG. 6. The frequent operations of the resilient member 56 can easily reach its point of fatigue. In other words, because of the orientation of the resilient member 56, the life of use of the resilient member 56 is shortened, and once the resilient member 56 is broken, the hammer tacker cannot be used.

The present invention intends to provide an operation assembly for a hammer tacker to improve the shortcomings mentioned above.

### SUMMARY OF THE INVENTION

The present invention relates to a hammer tacker which includes a body having a nail track, an operation assembly and a strike plate. The operation assembly drives the strike plate to eject the nails. The operation assembly includes an operation unit which has a passive end to drive a resilient member located above the nail track. The resilient member provides the operation assembly a force to return to its initial position. The resilient member has one end mounted to a positioning member which has an insertion inserted into one end of the resilient member, and a flange extends outward from one end of the insertion. The flange has an end face contacts the passive end of the operation unit so as to ensure the resilient member to be operated in a horizontal direction.

The primary object of the present invention is to provide a hammer tacker wherein the resilient member is always orientated and operated in horizontal direction so as to improve the shortcoming of the conventional hammer tacker.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show hammer tacker with the operation assembly of the present invention;

FIG. 2 is an exploded view of the operation assembly of the present invention;

FIG. 3 is a side view to show that the resilient member is not yet operated;

FIG. 4 is a side view to show that the resilient member is compressed during striking nails;

FIG. 5 is a side view show the conventional operation assembly wherein the resilient member is tilt, and

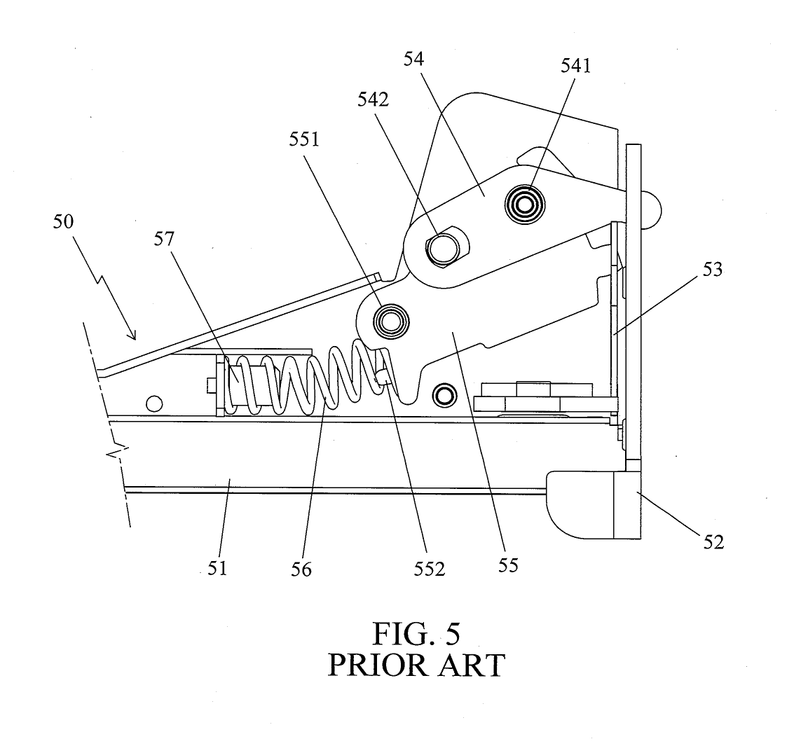

FIG. 6 is a side view show the conventional operation assembly wherein the resilient member is compressed in horizontal direction.

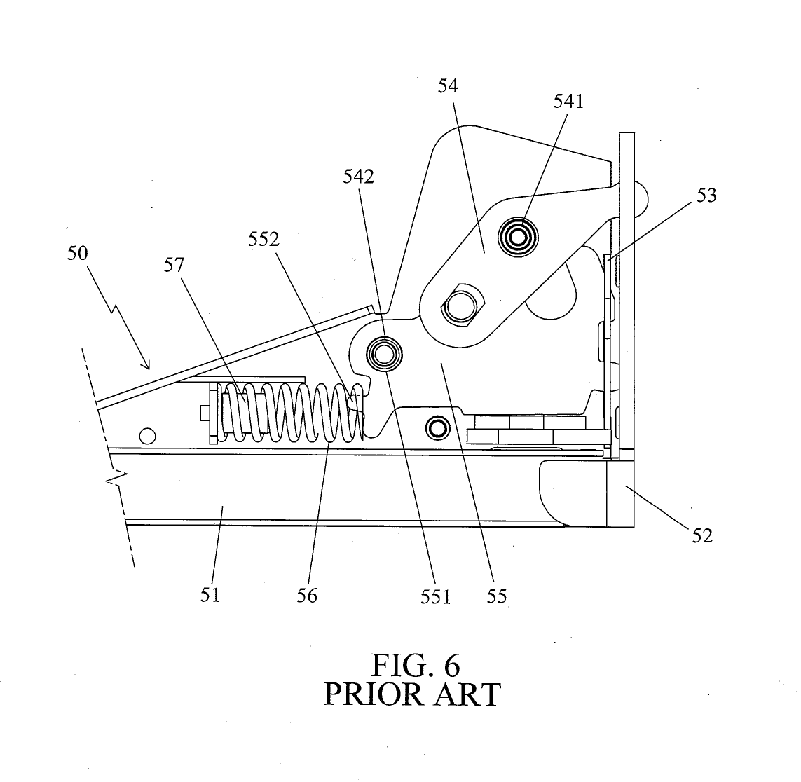

### DETAILED DESCRIPTION OF THE PREFERRED EMBODIMENT

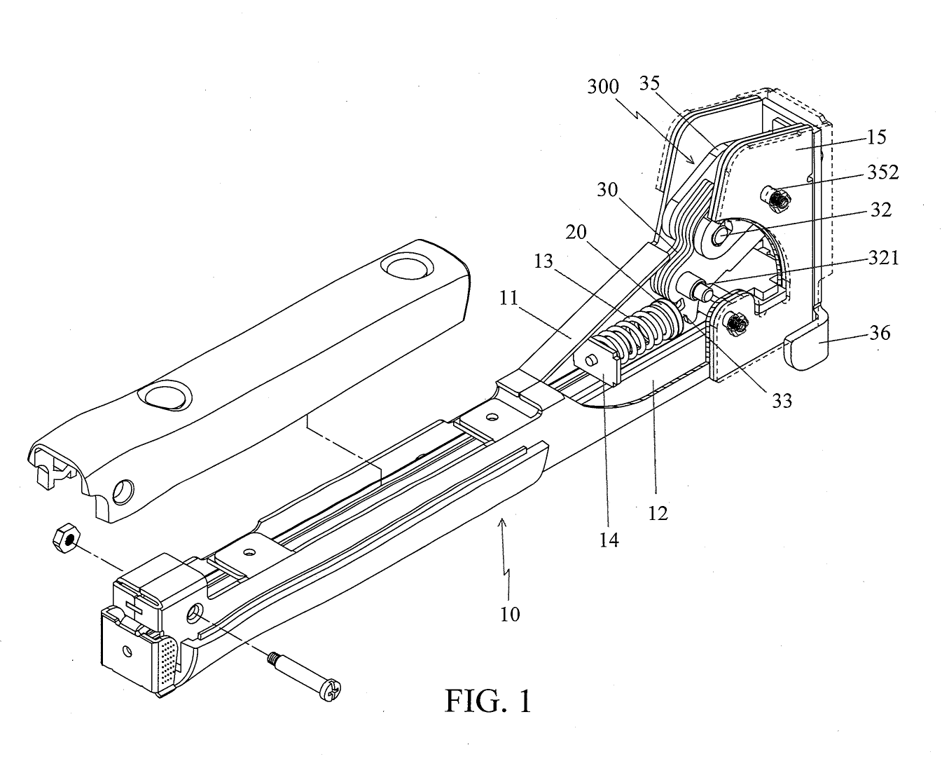

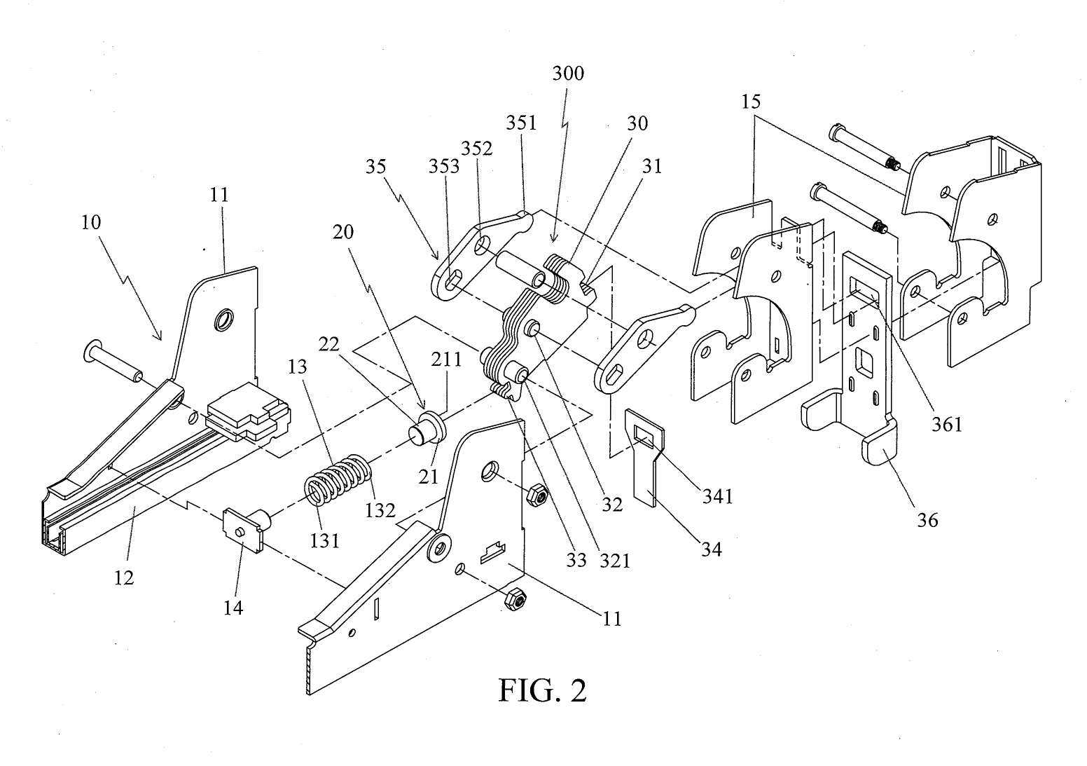

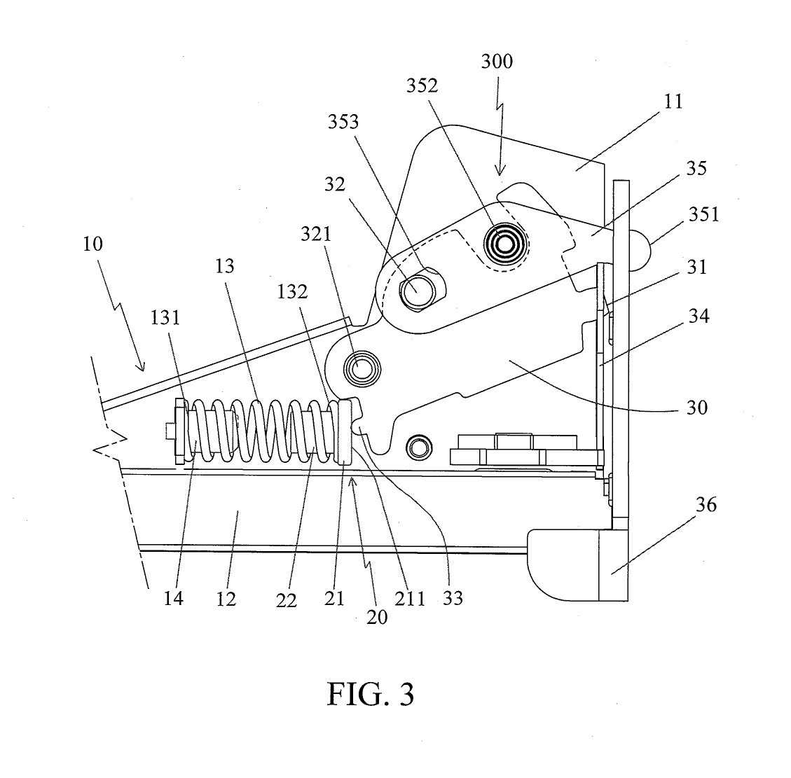

Referring to FIGS. 1 to 3, the hammer tacker of the present invention comprises an elongate body 10 and a nail track 12 is located in the body 10. Two side panels 11 are connected to the body 10 and the nail track 12 is received between the two side panels 11. A resilient member 13 is located within the space between the two side panels 11 and has a first end 131 and a second end 132. The first end 131 is connected to a fixed member 14 fixed to the body 10, and the second end 132 of the resilient member 13 is mounted to a positioning member 20. The positioning member 20 has an insertion 22 inserted into one end of the resilient member 13. A flange 21 extends outward from one end of the insertion 22 and has an end face 211. The end face 211 of the positioning member 20 is a flat face. The positioning member 20 is restricted by ribs in the body 10 so as to be movable along a horizontal path. The resilient member 13 is always located in horizontal direction.

An end cap unit 15 is connected to the front end of the body 10 and includes two side plates which are connected to the two side panels 11. An operation assembly 300 is located within the space between the two side panels 11 and the end cap unit 15.

The operation assembly 300 comprises an operation unit 30, two links 35, an activation member 36, and a strike plate 34. The operation unit 30 includes a hooking portion 31 at the front end thereof, and a passive end 33 protrudes from the rear end of the operation unit 30. The passive end 33 contacts the end face 211 of the positioning member 20. A first pivot 32 extends from the two sides of the operation unit 30, wherein the first pivot 32 is located at substantially the upper and mediate portion of the operation unit 30. A second pivot 321 extends from the two sides of the operation unit 30 and located close to the rear end of the operation unit 30. Each of the two ends of the second pivot 321 is inserted into the hole (not numbered) of the side panel 11 corresponding thereto. The two links 35 are respectively located on the two sides of the operation unit 30 and each have a pivot hole 352 and an elongate slot 353. The two ends of the first pivot 32 are respectively engaged with the slots 353 of the two links 35. A pin (not mentioned) is rested in a recess defined in the top of the operation unit 30 and located close to the front end of the operation unit 30, and the two ends of the pin are inserted into the two pivot holes 352 of the two links 35. The two links 35 each have a protruded end 351. The end cap unit 15 has two parts, one of the parts has two notches. The two protruded ends 351 movably extend through the two notches and inserted into an insertion hole 361 of an activation member 36 which is located between the two parts of the operation unit 30. The lower end of the activation member 36 protrudes beyond the lowest end of the body 10. The strike plate 34 is located between the end cap unit 15 and the operation unit 30, and the hooking portion 31 hooks an engaging hole 341 of the strike plate 34.

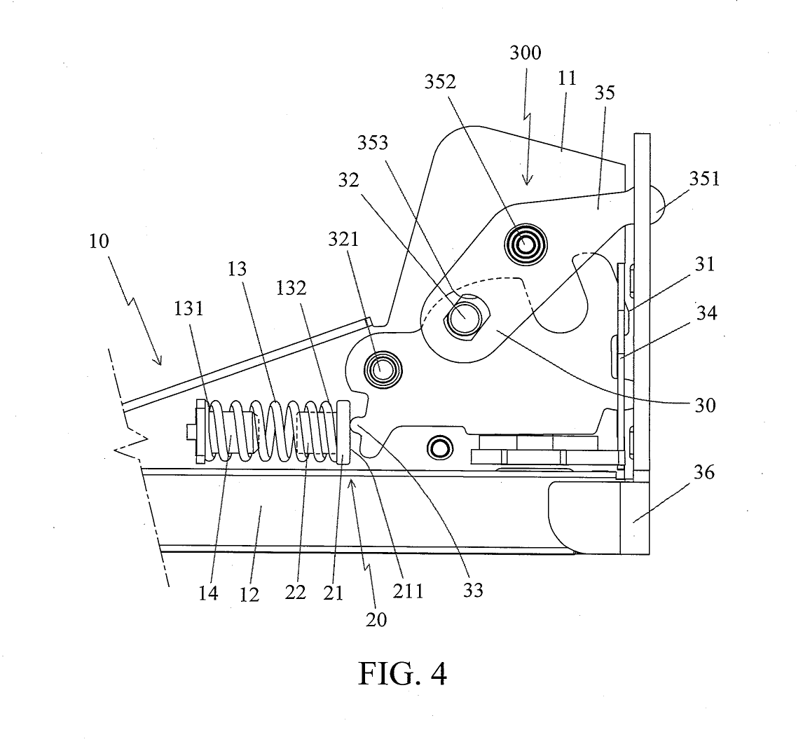

When using the hammer tacker, as shown in FIG. 4, the user holds the handle of the body 10 and hits the object to be nailed, the lower end of the activation member 36 that protrudes beyond the lowest end of the body 10 is pushed upward by the object so that the protruded ends 351 that are inserted into the insertion hole 361 are lifted, and the links 35 are pivoted about the pin extending through the pivotal holes 352. The pivotal action of the links 35 makes the two sides of the first pivot 32 to move within the slots 353 and pivots the operation unit 30 to pivot about the second pivot 321. The passive end 33 pushes the positioning member 20 to compress the resilient member 13. In the same time, the hooking portion 31 is lowered and drives the strike plate 34 to eject nails in the nail track 12.

After ejection one nail, the resilient member 13 bounces back and provides a force to the operation unit 30 to pivot the second pivot 321 so as to return the operation unit 30 to its initial position.

It is noted that the resilient member 13 is always maintained in the horizontal direction when nailing the object. The resilient member 13 does not tilt during operation, and the resilient force is completely used to pivot the operation unit 30 which drives the strike plate 34 to eject the nails. Therefore, the life of use of the resilient member 13 is prolonged when compared with the conventional resilient member.

While we have shown and described the embodiment in accordance with the present invention, it should be clear to those skilled in the art that further embodiments may be made without departing from the scope of the present invention.

What is claimed is:

1. A hammer tacker comprising:
a body having a nail track located therein;
an operation assembly driving a strike plate to eject nails in the nail track, the operation assembly having an operation unit which has a passive end to drive a resilient member located above the nail track, the resilient member providing the operation assembly a force to return the operation assembly to its initial position, the resilient member having a first end and a second end, the first end connected to a fixed member of the body, the second end mounted to a positioning member, the positioning member having an insertion inserted into one end of the resilient member, and a flange extending outward from one end of the insertion, the flange having an end face, the passive end of the operation unit contacting the end face to ensure the resilient member to be operated in a horizontal direction.

2. The hammer tacker as claimed in claim 1, wherein the end face of the positioning member is a flat face.
